(19) United States
(12) Patent Application Publication
(10) Pub. No.: US 2016/0259922 A1
(43) Pub. Date: Sep. 8, 2016

(54) SOFTWARE LICENSE MANAGEMENT METHOD AND SYSTEM

(71) Applicant: SHIMADZU CORPORATION, Kyoto-shi, Kyoto (JP)

(72) Inventor: Kiriko MATSUO, Kyoto-shi (JP)

(73) Assignee: SHIMADZU CORPORATION, Kyoto-shi, Kyoto (JP)

(21) Appl. No.: 15/033,154

(22) PCT Filed: Oct. 31, 2013
(86) PCT No.: PCT/JP2013/079621

§ 371 Date: Apr. 29, 2016

(51) Int. Cl. G06F 21/10; G06F 21/12; H04L 29/06

(52) U.S. Cl. CPC G06F 21/105; H04L 67/42; H04L 63/102; G06F 21/121; G06F 2221/0773

(57) ABSTRACT

Provided is a method relating to license authentication of software used in a system including a plurality of servers, the method being for solving unbalance regarding license among the servers so as to enhance license use efficiency. In one server computer, when a license request is issued from a client computer connected to the one server computer or the like, it is determined whether or not the number of licenses installed on the one server computer is exceeded as a result of the license request (Steps S14 and S15). In the case where it is determined that the number of installed licenses is exceeded, the license request is transmitted to another server computer connected to the one server computer (S15→S16, S16→S17, and the like).

### TECHNICAL FIELD

The present invention relates to a license management technique for protecting software such as computer programs and contents against copying.

### BACKGROUND ART

Creation of computer programs and contents requires more and more time and effort, and the need for technical means (license techniques) for collecting compensations by appropriately selling the resultant products becomes higher and higher. Moreover, expectations for advanced license techniques are high not only from the perspective of such compensation collection but also from the perspective of limited distribution to a desired range (or prevention of distribution to an undesired range).

When, in a client server system 10 including a server computer 11 and a plurality of client computers 12 to 15 connected via a network as illustrated in FIG. 1, for example, a program is installed on the plurality of client computers 12 to 15, two methods are possible: installing licenses on the client computers 12 to 15; and collectively installing licenses on the server computer 11. Installing licenses can be made by: using hardware such as a USB dongle; or installing licenses on the computers 11 to 15 in the form of software. Separately from the license, the program that is made usable by the license may be installed on each of the client computers 12 to 15, or may be installed on the server 11. In some cases, functions of a program are installed separately so that part of the functions are installed on the client computers 12 to 15, and the other functions are installed on the server computer 11 (Patent Literature 1).

In a large-scale system, as illustrated in FIG. 2, several servers 21 and 22 each connected to a plurality of client computers 23 to 25 or 26 to are connected to each other. In this case, also, licenses are installed either on the client computers 23 to 28 or on the server computers 21 and 22.

### CITATION LIST

### Patent Literature

[Patent Literature 1] JP 2004-213436 A

### SUMMARY OF INVENTION

### Technical Problem

If a license is installed on every client computer, the workload for installing the licenses is very heavy when the number of client computers is large. In addition, some licenses should be maintained even for least-used client computers, which substantially raises the license fee. Moreover, depending on the system environment, the system security management is too strict to acquire the permission to install the program on each client computer and to install the program on each client computer in an average time. When, on the contrary, the system management is inadequate, and a license is managed on every client computer, it is difficult to constantly grasp the number of licenses installed in the whole system.

In the case where licenses are managed on the server computer, normally licenses are not prepared as many as the number of the client computers. Instead, a number of licenses that are expected to be used at a time are generally installed on the server computer. However, as described above, conventionally it is only possible that licenses are installed on each server computer. Hence, if the number of client computers actually used for each server computer is uneven, some of the client computers of a server computer cannot use the license while some licenses remain unused on another server computer.

An object of the present invention is to provide a method for solving such unbalance in license among server computers and enabling more efficient license utilization.

### Solution to Problem

A license management method according to the present invention, which has been made in order to achieve the above-mentioned object, is a license management method in a client server system in which a plurality of server computers are connected to each other, one or a plurality of client computers are connected to each server computer, and a predetermined number of licenses are installed on each server computer, including the steps of:

determining, in one server computer, whether or not a number of licenses installed on the one server computer is exceeded as a result of a license request, when the license request is issued from a client computer connected to the one server computer, from the one server computer itself, or from another server computer;

granting one of the licenses installed on the one server computer in response to the license request, in a case where it is determined that the number of licenses installed on the one server computer is not exceeded as the result of the license request; and

transmitting the license request to another server computer connected to the one server computer, in a case where it is determined that the number of licenses installed on the one server computer is exceeded as the result of the license request.

The present invention can also be achieved as a license management system including, in a client server system in which a plurality of server computers are connected to each other, one or a plurality of client computers are connected to each server computer, and a predetermined number of licenses are installed on each server computer:

a number-of-licenses determining unit provided to each server computer for determining whether or not a number of licenses installed on the one server computer is exceeded as a result of a license request, when the license request is issued from a client computer connected to the one server computer, from the one server computer itself, or from another server computer;

a license grant unit provided to each server computer for granting one of the licenses installed on the one server computer in response to the license request, in a case where the number-of-licenses determining unit determines that the number of licenses installed on the one server computer is not exceeded as the result of the license request; and

a license request transferring unit provided to each server computer for transmitting the license request to another server computer connected to the one server computer, in a case where the number-of-licenses determining unit determines that the number of licenses installed on the one server computer is exceeded as the result of the license request.

Here, the order of license request transfer among server computers follows the rule of general data transfer among server computers in the system. In addition, such a data transfer rule that gives priority to the license request transfer may be provided. For example, in the case of widely-used Windows®OS, it is not easy to access a transfer-destination server computer in another network segment. Accordingly, by setting in advance an IP address and a port number of each server computer on which licenses are installed (or by providing a unit for holding such license server information) to multiple or all of the server computers, searching across network segments is facilitated. Moreover, in the case where security authentication is necessary for access among server computers, a configuration function may be provided to enable automatic authentication for a license request.

### Advantageous Effects of Invention

In the license management method and the license management system according to the present invention, in the case where a given server computer cannot meet a license request (that is, in the case where licenses are lacking in the given server computer), the license request is transferred to another server computer connected to the given server computer. If the server computer that received the license request from the given server has remaining licenses, the license request can be met using the remaining licenses. In the case where licenses are lacking also in the server computer, the license request is further transferred to another server computer. In this way, the license management method according to the present invention enables license sharing among the server computers. Hence, from the users' viewpoint, the license use efficiency is enhanced, and the costs are reduced. Moreover, a burden on administrators is reduced. From the software providers' viewpoint, the software is more likely to be properly purchased as software with high use efficiency, and compensations for the software can be appropriately collected.

Normally, if there is no response to a license request within a predetermined time period, a client computer (or server computer) that issues the license request determines that no license is usable, and does processing accordingly, which causes no special problem. However, in order to avoid unnecessary communication congestion, it is possible to set an upper limit of the number of times of license request transfer.

### BRIEF DESCRIPTION OF DRAWINGS

FIG. 1 is a configuration diagram of an example of a client server system including a single server computer.

FIG. 2 is a configuration diagram of an example of a client server system including a plurality of server computers.

FIG. 3 is a flowchart of a license management method according to an embodiment of the present invention.

FIG. 4A and FIG. 4B are explanatory views illustrating the relation between functions and licenses for each license type.

FIG. 5A and FIG. 5B are operation explanatory views of functions and licenses for each license type.

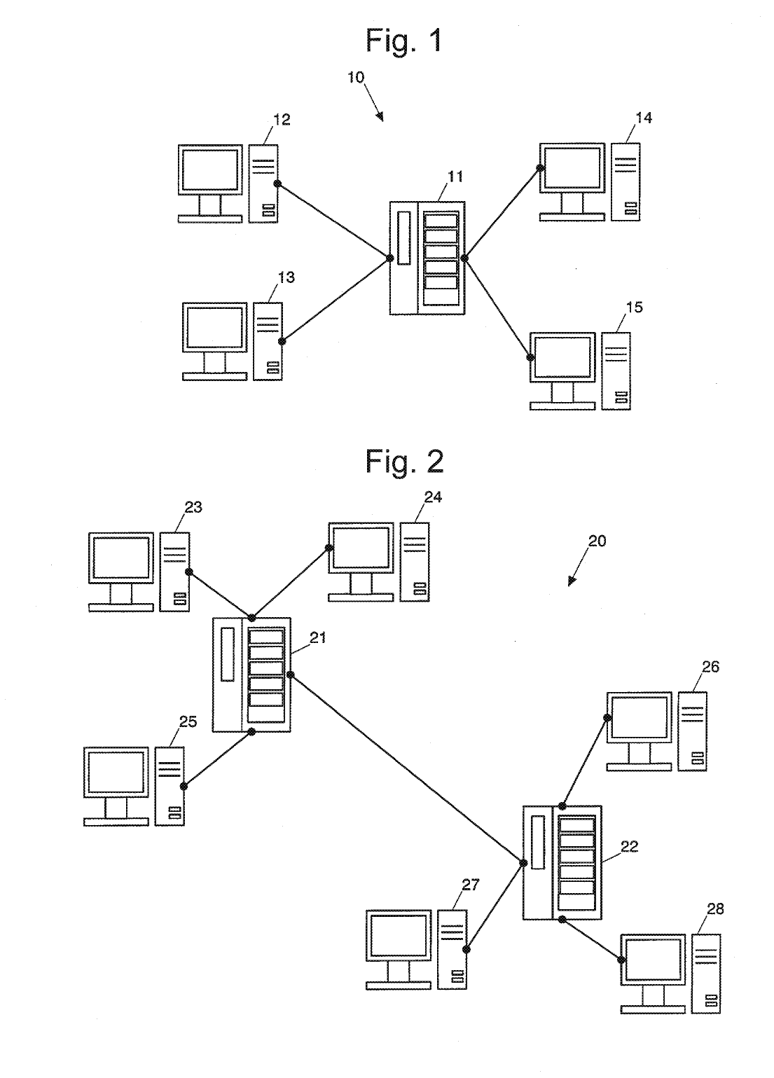

### DESCRIPTION OF EMBODIMENTS

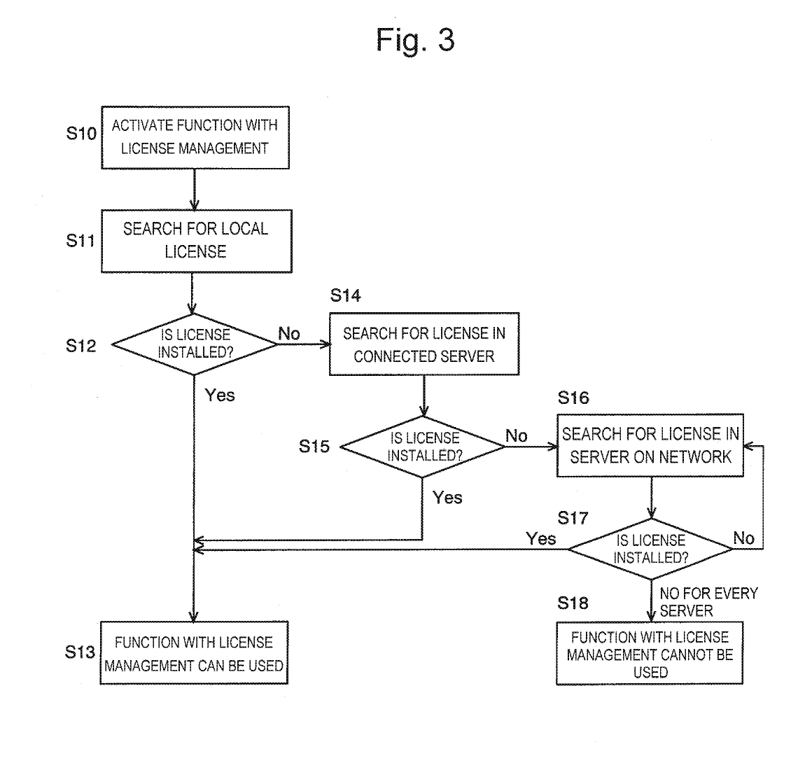

An embodiment of a license management method according to the present invention is described with reference to FIG. 2 and FIG. 3. A system according to the present embodiment is a client server system 20 including two server computers 21 and 22 each connected to three client computers 23 to 25 or 26 to 28 as illustrated in FIG. 2. Assume that an application having a function that requires license authentication is activated in any of the computers (the client computers 23 to 28 or the server computers 21 and 22) included in this system. Although the application and the function themselves are installed on each of the client computers 23 to 28 and the server computers 21 and 22, the license authentication is required in order to correctly use the function after activating the application. Assume that necessary licenses are installed on the first and second server computers 21 and 22 and that the number of the installed licenses is one on the first server computer 21 and two on the second server computer 22. The licenses may be installed as hardware by using a USB or the like, or may be installed as software by storing the licenses into a registry or a particular location. Alternatively, the licenses may be installed selectively hardware or software, or in combination.

When a user activates the application on the client computer 23 connected to the first server computer 21 to use a function that requires a license (Step S10), the application first issues a license request to the client computer 23, and searches for the license (local license) in the client computer 23 (Step S11). If the client computer 23 has the local license, the user can use the function on the client computer 23 (Steps S12→S13).

If the local license is not installed on the client computer 23 (this case applies here), the application issues a license request to the server computer 21 to which this client computer is connected, and searches for the license in the server computer 21 (Step S14). If the server computer 21 has the license (the license remains on the server computer 21), the user can use the function on the client computer 23 (Steps S15→S13).

If the same function of this application is already used by a different client computer (for example, the client computer 24) connected to the first server computer 21, the application on the different client computer already uses one license on the first server computer 21. In this case, because the license on the first server computer 21 is already occupied, the application on the client computer 23 cannot use (obtain) the license on the first server computer 21.

Consequently, the application on the client computer 23 refers to a license holding database for the application, which is provided to the first server computer 21, and finds that the second server computer 22 has the licenses.

Based on this information, the application on the client computer 23 issues a license request to the second server computer 22 to queries whether or not the second server computer 22 has the license of the application (the license is usable) (Step S16). If the second server computer 22 has the license (the license remains on the second server computer 22), the second server computer 22 sends a signal of permission to the license request to the application on the client computer 23, and the user can use the function on the client computer 23 (Steps S17→S13). In the case where the two licenses on the second server computer 22 are already used so that no license is usable on the second server computer 22, the application on the client computer 23 further searches for another server that holds the license based on the license holding database. If another server computer that holds the license is searched out, the application on the client computer 23 searches for the license in this server computer (Steps S17→S16). On the other hand, if no server computer that holds the license is searched out, the function of the application that requires the license cannot be used on the client computer 23 (Steps S17→S18).

In this way, in the system of the present embodiment, the user using the system can use any of the licenses within the total number of the licenses installed on the server computers connected via the network. This is very convenient to the user and efficient for an administrator, and realizes easy license management at low cost. Such convenience to the user and the administrator leads to an increase in use frequency of the application, which is also advantageous to a provider of the application.

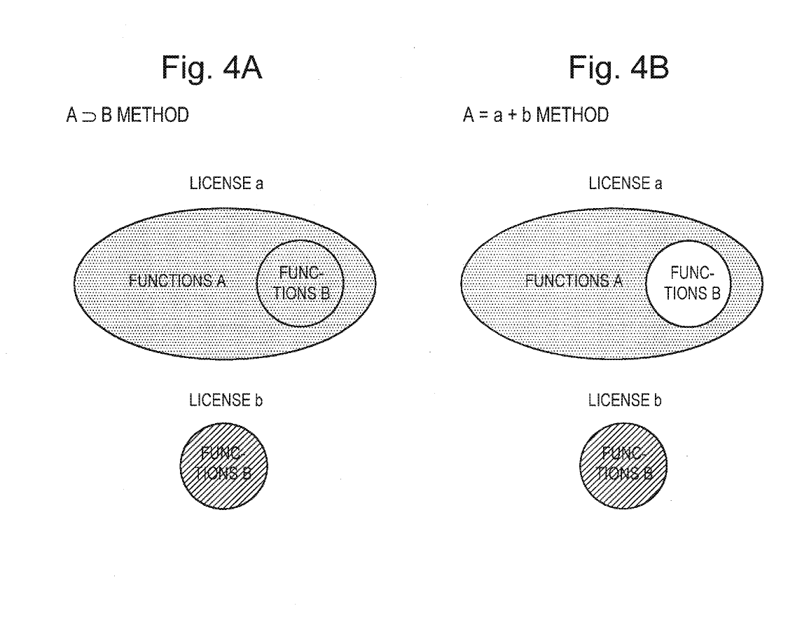

The above description is given of the case where one license is necessary for one function. Depending on the type of a license, different licenses may be necessary for a plurality of functions under inclusion relation. For example, for word-processing software, a license “a” necessary to use all functions A of the word-processing software and a license “b” necessary to use general functions B of all the functions A may be separated (individually sold). For example, in the case of commercially available high-function word-processing software, macro development is possible if all functions are usable, whereas macro development is not possible if only general functions are usable. In this case, if the license “a” is installed, the functions B as well as the functions A can be used, and this corresponds to a relation of A⊃B (FIG. 4A). Meanwhile, a license “b” is separately necessary to use functions B in some cases. For example, a license “a” for only the general functions A and the license “b” for only the functions B for macro development are separately prepared, and this corresponds to a relation of A=a+b (FIG. 4B). The former is referred to as an A⊃B method, and the latter is referred to as an A=a+b method.

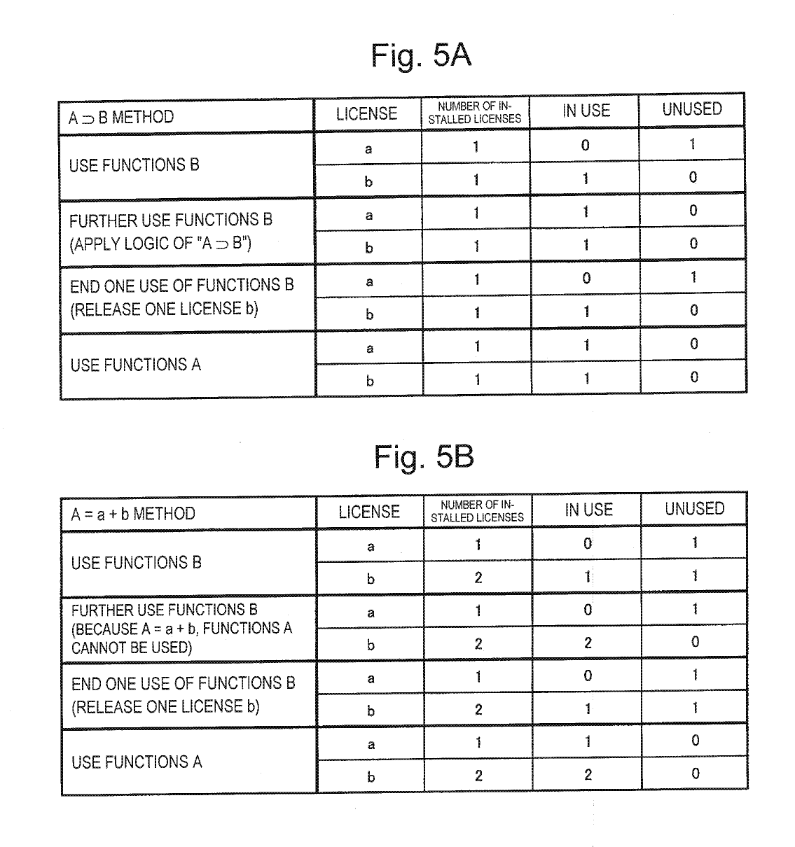

In the case of the A⊃B method, assume that one license “a” and one license “b” are installed in total on the first server computer 21 and the second server computer 22. These licenses may be collectively installed on either of the server computer 21 or 22, or may be divided in two server computers. In this case, a specific use form is as illustrated in FIG. 5A. That is, first, in the case of using the limited functions B, a user uses the license “b”. Then, if a second user tries to use the same functions B, the license “b” is already used. In this case, because the license “a” can be used as the license for the functions B in the A⊃B method, the second user can use the functions B by using the license “a”. Then, when the second user ends the use of the functions B, the license “a” is released. Consequently, another user can use the functions A.

In the case of the A=a+b method, a larger number of licenses are generally necessary. Assume that one license “a” and two licenses b are installed in total on the first server computer 21 and the second server computer 22. Similarly to the above, these licenses may be collectively installed either of the server computer 21 or 22, or may be divided in the two server computers. In this case, a specific use form is as illustrated in FIG. 5B. That is, first, in the case where a first user uses the functions B, the first user uses one license “b”. In the case where a second user uses the same functions B, because A=a+b, the second user cannot use the license a, and thus needs to use the remaining one license “b”. Then, when any of the two users ends the use of the functions B, one license “b” is released to become usable by a third user. Then, in the case where another user uses the functions A, this user uses one license a, and also uses one license “b” in order to make the functions B usable.

In any of the above-mentioned cases, in the system according to the present invention, as long as a license is installed on any of the server computers in the system, the license can be used, and hence a variety of types of licenses can be handled depending the situation.

### REFERENCE SIGNS LIST

10, 20 . . . Client Server System
11 . . . Server Computer
12 to 15 . . . Client Computer
21 . . . First Server Computer
22 . . . Second Server Computer
23 to 28 . . . Client Computer

1. A license management method in a client server system in which a plurality of server computers are connected to each other, one or a plurality of client computers are connected to each server computer, and a predetermined number of licenses are installed on each server computer, the method comprising the steps of:
determining, in one server computer, whether or not a number of licenses installed on the one server computer is exceeded as a result of a license request, when the license request is issued from a client computer connected to the one server computer, from the one server computer itself, or from another server computer;
granting one of the licenses installed on the one server computer in response to the license request, in a case where it is determined that the number of licenses installed on the one server computer is not exceeded as the result of the license request; and
transmitting the license request to another server computer connected to the one server computer from the client computer, in a case where it is determined by the one server computer that the number of licenses installed on the one server computer is exceeded as the result of the license request.

2. The license management method according to claim 1, wherein an IP address and a port number of each server computer on which the licenses are installed are set in advance to multiple or all of the server computers.

3. A license management system comprising, in a client server system in which a plurality of server computers are connected to each other, one or a plurality of client computers are connected to each server computer, and a predetermined number of licenses are installed on each server computer:
a number-of-licenses determining unit provided to each server computer for determining whether or not a number of licenses installed on the one server computer is exceeded as a result of a license request, when the license request is issued from a client computer connected to the one server computer, from the one server computer itself, or from another server computer;
a license grant unit provided to each server computer for granting one of the licenses installed on the one server computer in response to the license request, in a case where the number-of-licenses determining unit determines that the number of licenses installed on the one server computer is not exceeded as the result of the license request; and
a license request transmitting unit provided to each client computer for transmitting the license request to another server computer connected to the one server computer, in a case where the number-of-licenses determining unit determines that the number of licenses installed on the one server computer is exceeded as the result of the license request.

4. The license management system according to claim 3, wherein a license server information holding unit to which an IP address and a port number of each server computer on which the licenses are installed are set in advance is provided to multiple or all of the server computers.
